(19) United States
(12) Patent Application Publication
(10) Pub. No.: US 2007/0115888 A1
(43) Pub. Date: May 24, 2007

(54) Method for reverse data processing in a mobile communication system

(75) Inventor: Hyun Goo Lee, Anyang-si (KR)

Correspondence Address: KED & ASSOCIATES, LLP, P.O. Box 221200, Chantilly, VA, 20153-1200, US

(73) Assignee: LG-Nortel Co., Ltd.

(21) Appl. No.: 11/544,867

(22) Filed: Oct. 10, 2006

(30) Foreign Application Priority Data
Oct. 11, 2005 (KR) 10-2005-0095619

(51) Int. Cl. H04Q 7/00; H04L 12/28

(52) U.S. Cl. 370/331; 370/431

(57) ABSTRACT

A method is provided of performing reverse data processing in a mobile communication system that can prevent data error caused by lack of synchronization in data from a plurality of base stations at a time of handoff in the communication system. The method may include establishing a predetermined total receiving time and receiving MAC packets from each of the base stations in an active state when handoff begins at the mobile terminal. The method may also include determining whether the predetermined total receiving time has expired and generating RLP data according the received MAC packets if the total receiving time has expired.

The present application claims priority from Korean Patent Application No. 10-2005-0095619, filed Oct. 11, 2005 and entitled “METHOD FOR REVERSE DATA PROCESSING IN A MOBILE COMMUNICATION SYSTEM,” the subject matter of which is incorporated herein by reference.

### BACKGROUND

1. Field

Embodiments of the present invention may relate to reverse data processing in a mobile communication system. More particularly, embodiments of the present invention may relate to a method of performing reverse data processing in a mobile communication system that can prevent data error caused by lack of synchronization in data from a plurality of base stations at a time of handoff.

2. Background

1× Evolution for Data Only (EVDO) Rev. A was developed and supports a transfer rate of 1.8 Mbps, which is 12 times faster than a transfer rate of CDMA2000 1×EVDO. The rapid transfer rate of EVDO Rev. A is attributed to an improvement in up-link rate that limits an overall performance of the CDMA2000 1×EVDO. Since 1×EVDO Rev. A also has a down-link rate of 3.1 Mbps that is faster than EVDO, 1×EVDO Rev. A is capable of supporting video call and multimedia services.

To improve the up-link rate, a hybrid automatic repeat request (HARQ) using automatic repeat request (ARQ) to a backward channel in a physical layer may be applied to the EVDO Rev. A. An error control algorithm may be categorized into two different types (i.e., ARQ and forward error correction). While ARQ is implemented in a data link protocol of an open system interconnection (OSI) model, forward error correction is implemented in the physical layer. Since HARQ corrects errors caused by the combination of the ARQ method and channel coding in the physical layer, it may improve the processing rate of mass packet data.

However, a problem may arise when applying the HARQ method to a backward channel. The data from each of the base stations may not be properly synchronized during handoff. Thus, data errors may occur when reconstructing the packets.

### SUMMARY

Embodiments of the present invention may relate to a method of performing reverse data processing in a mobile communication system that can prevent (or reduce) data error caused by lack of synchronization in data from a plurality of base stations at a time of handoff by using a hybrid automatic repeat request (HARQ) for a backward channel.

A method may be provided of performing reverse data processing in a mobile communication system that includes establishing a predetermined total receiving time, and receiving media access control (MAC) packets from each base station in an active state when handoff begins for a mobile terminal. The method may also include determining whether the total receiving time has passed and generating radio link protocol (RLP) data according to the received MAC packets if the total receiving time has passed.

Receiving the MAC packets may include receiving sequence information and system time information of the MAC packets.

The method may further include determining whether all the MAC packets have been received if the total receiving time has not passed, and generating RLP data according to the MAC packets if all of the MAC packets have been received.

### BRIEF DESCRIPTION OF THE DRAWINGS

The foregoing and other aspects and advantages may be further understood from the following detailed description taken in conjunction with the drawings, in which like reference numerals refer to like elements and wherein:

FIG. 1 is a schematic diagram of a mobile communication system in accordance with an example embodiment of the present invention;

FIG. 2 illustrates a process of receiving reverse data in a mobile communication system according to an example embodiment of the present invention; and

FIG. 3 illustrates a flowchart showing a method of performing reverse data processing in a mobile communication system according to an example embodiment of the present invention.

### DETAILED DESCRIPTION

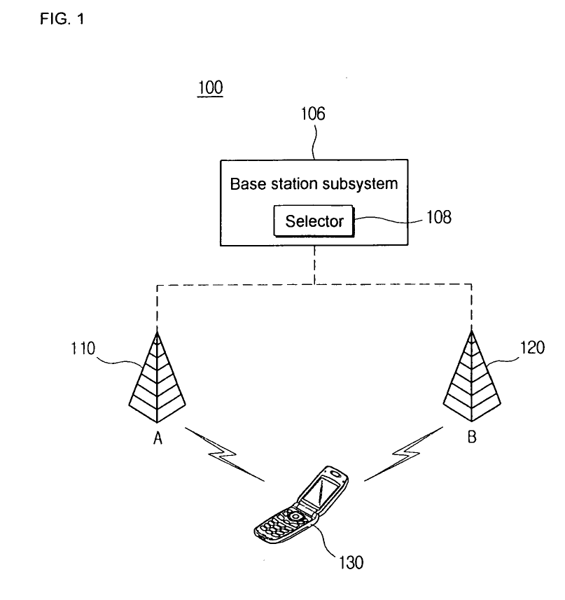

FIG. 1 is a schematic diagram of a mobile communication system in accordance with an example embodiment of the present invention. Other embodiments and configurations are also within the scope of the present invention.

More specifically, FIG. 1 shows a mobile communication system 100 that includes a mobile terminal 130, a plurality of base stations 110 and 120, a base station subsystem 106, and a selector 108 of the base station subsystem 106. Although FIG. 1 illustrates only two base stations 110 and 120, this is merely exemplary as there may be other numbers of base stations. The mobile terminal 130 communicates with at least one of the base stations 110 and 120, and the selector 108 receives packet data from at least one of the base stations 110 and 120. The base station 110 may also be referred to as the base station A 110. The base station 120 may also be referred to as the base station B 120.

Handoff begins as the mobile terminal 130 moves. Each of the base stations 110 and 120 may transfer MAC packets to the selector 108 of the base station subsystem 106 when they have received the MAC packets from the mobile terminal 130. When transferring the MAC packets, additional information for implementing an efficient operation of the selector 108 (e.g., sequence information and system time of the MAC packets) may also be transferred.

However, when applying HARQ to a backward data channel, the selector 108 may receive the MAC packets at different times. Furthermore, data corresponding to a sub-frame included in these MAC packets may be different for each other. That is, the reception of the MAC packet sequence, each of which constitutes a basic unit of the data, may be decoded differently according to each of the base stations 110 and 120.

Accordingly, after establishing a predetermined total receiving time, the selector 108 only receives the MAC packets from each of the base stations 110 and 120 during the total receiving time. When the total receiving time has expired, the selector 108 generates radio link protocol (RLP) data to reconstruct the MAC packets by the combination of the MAC packets received from each of the base stations 110 and 120. If some of the MAC packets are only received from the base stations 110 and 120 in active states until the total receiving time expires, then the selector 108 may construct RLP data for only the received MAC packets. The selector 108 may then process the delayed MAC packets, which are received after the total receiving time expires, based on a determination of whether the MAC packets are delayed packets or new packets. This determination may consider MAC packet sequences.

Since the selector 108 knows a number of the active base stations 110 and 120, the selector 108 may immediately generate RLP data when the MAC packets are completely received from all of the active base stations 110 and 120 even though the total receiving time has not yet expired.

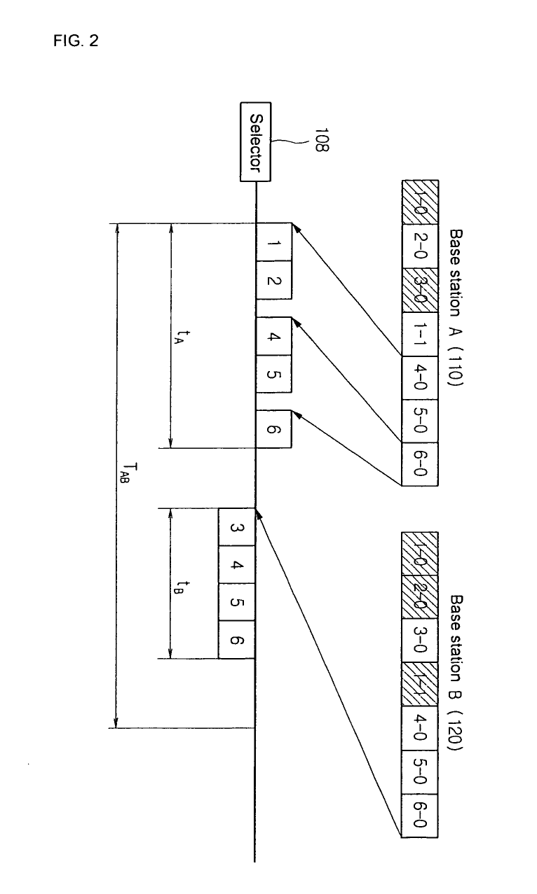

FIG. 2 illustrates a process of receiving reverse data in a mobile communication system according to an example embodiment of the present invention. Other embodiments and processes are also within the scope of the present invention. More specifically, FIG. 2 shows a process when the base stations A 110 and B 120 are in active states.

In the example of FIG. 2, of seven MAC packets (1-0, 2-0, 3-0, 1-1, 4-0, 5-0, 6-0) of the base station A 110, the MAC packets 1, 2, 4, 5 and 6 are received by a receiving device of the selector 108 and the two MAC packets (1-0, 3-0) are lost. In such a case, the selector 108 is in a stand-by state during a time period t_{A} to receive the MAC packets from the base station A 110.

Additionally, of the seven MAC packets (1-0, 2-0, 3-0, 1-1, 4-0, 5-0, 6-0) of the base station B 120, the MAC packets 3, 4, 5 and 6 are received by a receiving device of the selector 108 and the three MAC packets (1-0, 2-0, 1-1) are lost. In such a case, the selector 108 is in the stand-by state during a time period t_{B} to receive the MAC packets from the base station B 120.

In other words, the selector 108 receives and stores the MAC packets that maintain a stand-by state during a total period T_{AB} to receive the MAC packets from the base stations A 110 and B 120 in the active states. The selector 108 then generates RLP data upon considering sequences of the MAC packets received from each of the base stations 110 and 120 when the waiting time T_{AB} expires. Accordingly, although the data from each of the base stations 110 and 120 are not synchronized, the data may be processed without any errors by suspending the process for a sufficient time period (T_{AB}) in order to receive all of the MAC packets sent by the base stations A 110 and B 120 in the active states.

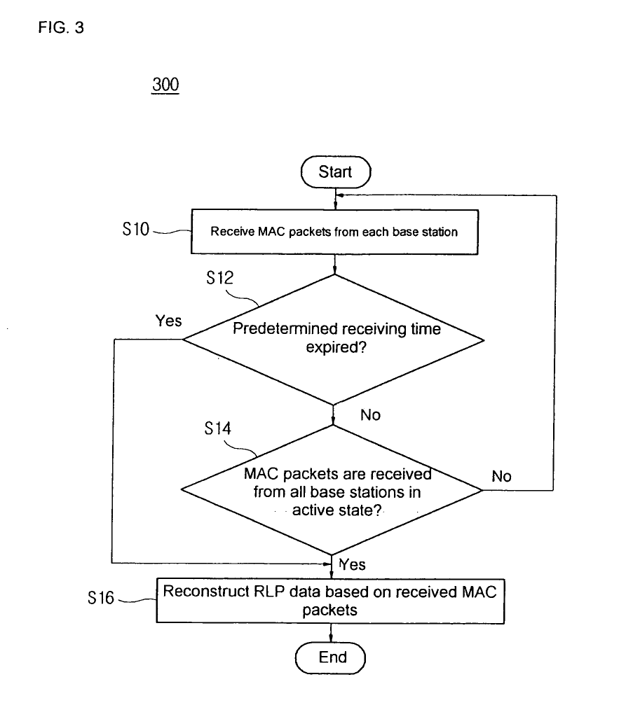

FIG. 3 illustrates a flowchart showing a method of performing reverse data processing in a mobile communication system according to an example embodiment of the present invention. Other operations, orders of operations and embodiments are also within the scope of the present invention. Operation S10 may be performed by a receiving device and operations S12, S14 and S16 may be performed by a processor device.

The method (300) shown in FIG. 3 begins in operation S10 where the selector 108 receives the MAC packets from each of the base stations 110 and 120 in the active states when handoff begins due to movement of the mobile terminal 130. The MAC packets may be received with sequence information and system time information. In operation S12, the selector 108 may determine whether the predetermined total receiving time has expired (or lapsed). If the total receiving time has passed (or expired), then in operation S16 the selector 108 generates RLP data based on the received MAC packets and additional information received with the MAC packets. The total receiving time may be established for receiving the MAC packets from all of the base stations 110 and 120 in the active states so as not to cause a long delay in the system operation.

If it is determined that the total receiving time has not passed, then in operation S14 the selector 108 determines whether the MAC packets have been received from all of the base stations 110 and 120 in the active states. If the MAC packets have been received from all of the base stations 110 and 120 in the active states, then the selector 108 in operation S16 immediately generates RLP data based on the received MAC packets and additional information received with the MAC packets in operation S16.

Embodiments of the present invention may provide a solution for a problem in which reverse data are received at different times due to differently decoding MAC packets in base stations in a mobile communication system using HARQ. Embodiments of the present invention may allow the selector to process RLP data after all the MAC packets have been received from each base station for a predetermined period. Embodiments of the present invention may prevent data error caused by a lack of synchronization in data from a plurality of base stations at a time of handoff

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of performing reverse data processing in a mobile communication system that includes a plurality of base stations, a mobile terminal and a selector, the method comprising:
establishing a total receiving time;
receiving media access control (MAC) packets from each of the base stations in an active state after handoff begins at the mobile terminal;
determining whether the total receiving time has expired; and
generating radio link protocol (RLP) data according to the received MAC packets if the total receiving time has expired.

2. The method of claim 1, wherein receiving the MAC packets includes receiving sequence information and system time information of the MAC packets.

3. The method of claim 1, further comprising:
determining whether all the MAC packets have been received from each of the base stations in the active state if the total receiving time has not expired; and
generating the RLP data according to the MAC packets if all the MAC packets have been received.

4. The method of claim 1, wherein the total receiving time is established such that the MAC packets are received from all the base stations and system operation is not delayed for more than a predetermined time.

5. A mobile communication method comprising:
determining a receiving time;
receiving packets from at least two base stations during an active state; and
generating radio link protocol (RLP) data based on the received packets and the determined receiving time.

6. The method of claim 5, wherein generating the RLP data includes generating the RLP data for only the received data that is received during the receiving time.

7. The method of claim 6, wherein the RLP data is generated based on sequences of the packets received from the at least two base stations.

8. The method of claim 5, further comprising processing delayed packets that are received at a selector after the receiving time.

9. The method of claim 8, wherein processing the delayed packets includes determining packet sequences.

10. The method of claim 5, wherein generating the RLP data includes generating the RLP data when the packets are completely received from the at least two base stations during the receiving time.

11. The method of claim 5, further comprising determining whether the receiving time has lapsed.

12. The method of claim 11, wherein generating the RLP data includes generating the RLP data based on the received packets if the receiving time has lapsed.

13. The method of claim 11, further comprising;
determining whether all the packets have been received from each of the base stations in the active state if the receiving time has not lapsed; and
generating the RLP data according to the received packets if all the packets have been received.

14. The method of claim 5, wherein receiving the packets includes receiving sequence information and system time information of the packets.

15. An apparatus in a mobile communication system comprising:
a receiving device to receive MAC packets from base stations; and
a processor device to generate radio link protocol (RLP) data based on received MAC packets and based on a determination of whether a total receiving time has lapsed.

16. The apparatus of claim 15, wherein the processor device generates the RLP data by generating the RLP data for only the received data that is received during the total receiving time.

17. The apparatus of claim 16, wherein the processor device generates the RLP data based on sequences of the MAC packets received from the at least two base stations.

18. The apparatus of claim 16, wherein the processor device further processes delayed MAC packets that are received by the receiving device after the total receiving time has lapsed.

19. The apparatus of claim 16, wherein the processor device processes the delayed MAC packets by determining packet sequences.

20. The apparatus of claim 15, wherein the processor device generates the RLP data by generating the RLP data when the MAC packets are completely received from the at least two base stations during the total receiving time.

21. The apparatus of claim 15, wherein the processor device further determines whether the total receiving time has expired.

22. The apparatus of claim 21, wherein the processor device generates the RLP data by generating the RLP data based on the received MAC packets if the total receiving time has lapsed.

23. The apparatus of claim 21, wherein the processor device further determines whether all the MAC packets have been received from each of the base stations in the active state if the total receiving time has not lapsed, and generates the RLP data according to the MAC packets if all the MAC packets have been received.

24. The apparatus of claim 15, wherein the processor device receives sequence information and system time information of the MAC packets.
